(19) United States
(12) Patent Application Publication
(10) Pub. No.: US 2004/0003038 A1
(43) Pub. Date: Jan. 1, 2004

(54) Live content processing for online presentation

(75) Inventors: Jong Huang, Bellevue, WA (US); Ian Marriott, Sammamish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/184,142

(22) Filed: Jun. 27, 2002

(51) Int. Cl. G06F 15/16

(52) U.S. Cl. 709/204

(57) ABSTRACT

A set of services or a collection of components are provided that work together to process information for online presentation, such as at Web sites. At least one service is provided upon start-up, with customizable, tag-based instruction files, which are interpretable by the service to process stabile content, live content, or both. Because the processing of stabile content, which is not transitory like live content, and the processing of live content, which can change drastically, may be separately handled by two different services, live content can be processed for online presentation more quickly, thereby reducing the instances in which users are unlikely to be presented with information that has become stale or irrelevant.

### FIELD OF THE INVENTION

The present invention relates generally to processing live content for online presentation, and more particularly, to a collection of component elements for processing stabile content, live content, or both for online presentation, such as at multiple Web sites.

### BACKGROUND OF THE INVENTION

There are certain types of knowledge, intelligence, news, facts, or data whose value lies not solely in the information itself but also in its timely presentation to users. One example is information about athletic events, which include sports or games engaged in by athletes involving physical strength, skill, endurance, and speed. The mass communication medium television transformed athletic events in the second half of the twentieth century by allowing more and more people to watch an event regardless of the event's location. The immediacy of the struggle of athletes in contests widely viewed by people transfigures such experiences into cultural experiences. The Olympic games, watched by millions worldwide, rivet people to their televisions to share moments of exhilaration and triumph as outstanding athletes compete on behalf of their nations. The timely presentation of information is key to this experience.

With the arrival of the World Wide Web, as a separate and independent mass communication medium, another transformation is taking place. Whereas television is an electronic system of transmitting and receiving transient images together with sound, the World Wide Web is a total set of interlinked Hypertext documents containing text (in a variety of fonts and styles), graphics images, movie files, and sounds as well as Java applets, ActiveX controls, or other small embedded software programs that execute when the user activates them by clicking on a link. Information to be processed and presented via the Web is primarily of two types: live content, which as the name implies, is dynamic and immediate; and stabile content, which is less dynamic and immediate than live content. For these types of information, a special set of problems exists in differentiating stabile content from live content, converting both types to Hypertext documents, and presenting these documents to users within a short duration of time.

A partial solution is provided by a system 100, as shown in FIG. 1A. The system includes a device 104 for capturing performance information from an athlete 102 and converting such information into messages for processing by a database 106. The database 106, which is a file composed of records, each containing fields together with a set of operations for searching, sorting, recombining, and other database functions, intercepts messages, processes them into multiple tables, and renders the information in these messages into a form suitable for sending to a Web site 112. The multiple tables, each of which has to be specially designed by a programmer who is well versed in the database art, are data structures characterized by rows and columns, with data occupying or potentially occupying each cell formed by a row-column intersection.

The use of the database 106 sacrifices efficiency for manageability. While stabile content may benefit from the manageability aspect of the database 106, the processing of live content suffers and is taxed in terms of precious time. Moreover, the performance of one table to process a few messages may be tolerable, but hundreds if not thousands of tables may be required to process thousands of messages containing stabile content, live content, or both coming from complex athletic events; such as the Olympic games, or other types of events that are not necessarily sports events. Lackluster performance of multiple tables in the database 106 prohibits their use in a situation where timely presentation is paramount to users' viewing experience. Also, new information captured during the happenings of events often cause abrupt changes to the organizational schemes of messages. The problem with the database 106 is that once designed, database tables are fixed. Redesigning, augmenting, or adding database tables on the fly to suit new organizational schemes of messages is simply not possible because of the time it takes specialized programmers to re-engineer and retest existing tables or program and test additional tables to accommodate new organizational schemes of messages.

Instead of using a database, another partial solution is to replace the database 106 with a compiled piece of software 108, as shown in FIG. 11B. While this solution is a slight advance over the database solution in terms of speed, the compiled piece of software 108 lacks the manageability of the database 106, plus shares all of the other problems associated with the database 106. For example, if drastic changes are made to the organizational scheme of the messages being forwarded by the device 104, the compiled piece of software 108 either has to be updated or scrapped and supplanted with another piece of compiled software. Like the database 106, a great amount of time is required to redesign, recompile, and retest updated software or new software. Moreover, even after extensive testing there is no guarantee that updated software or new software will not have coding or logic errors that could cause these pieces of software to malfunction or to produce incorrect results that could be catastrophic and ruin the viewing experience of users.

Thus, there is a need for better methods and systems for processing online content while avoiding or reducing the foregoing and other problems associated with existing processing schemes.

### SUMMARY OF THE INVENTION

In accordance with this invention, a method, system, and computer readable medium for processing stabile content, live content, or both for online presentation in a way that enhances users' viewing experience are provided. The system form of the invention comprises a set of services or a collection of component elements that work together to process messages for online presentation.

An aggregation service processes live content of messages to produce publishing messages. The aggregation service is provided with a customizable, tag-based instruction file that is used by the aggregation service to process live content to produce the publishing messages. The customizable, tag-based instruction file allows the aggregation service to adapt to changes in the messages that contain live content.

The publishing message produced by the aggregation service is forwarded to a publishing service. The publishing service is provided with a customizable, tag-based instruction file that is used by the publishing service to determine how to process various types of publishing messages.

In accordance with further aspects of this invention, the set of services includes a database service for processing messages that contain stabile content. The database service is provided with a customizable, tag-based instruction file that is used by the database service to process messages for storage and retrieval from a database. When an output file is produced by the database service for publishing, the publishing service binds the output file to a customizable, tag-based style file so that the content of the output file can be supplied online to one or more Web sites for the viewing by users.

In accordance with yet further aspects of this invention, multiple types of messages that contain stabile content, live content, or both, are forwarded to a message receiver. The message receiver is provided with a customizable, tag-based instruction file that is used by the message receiver to route a message to a corresponding service of the set of services based on the type of message. For example, when the message receiver receives a message containing live content, the message receiver forwards the message to the aggregation service. If the message contains stabile content, the message is forwarded to the database service.

Because the processing of stabile content, which is not transitory like live content, and the processing of live content, which can change drastically, are separately handled by the corresponding database service and the corresponding aggregation service, live content can be quickly provided to Web sites. Thus, a user visiting a Web site is unlikely to be presented with information that is stale or has become irrelevant, resulting in the user's viewing experience being more rewarding.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1B are block diagrams illustrating two conventional techniques for processing messages from sports events that have both stabile and live content prior to providing the information contained in the messages to a Web site.

FIG. 2 is a block diagram illustrating an exemplary computing device.

FIG. 3 is a pictorial diagram illustrating an exemplary Web page containing both stabile content as well as live content that has been processed according to the present invention.

FIG. 4 is a block diagram illustrating an exemplary computer system formed in accordance with the invention for processing messages that contain both stabile content and live content prior to supplying the information contained in the messages to multiple Web sites.

FIG. 5 is a block diagram illustrating in greater detail an exemplary computer system for processing messages that contain stabile content and live content, prior to supplying the information contained in the messages to a Web site.

FIG. 6 is a pictorial diagram illustrating an exemplary file system formed in accordance with this invention organized by directories, folders, and files accessible by contemporaneously executing threads for removing messages from queues and processing them for online presentation.

FIGS. 7A-7I are process diagrams illustrating an exemplary method formed in accordance with this invention for processing messages containing stabile content and live content for online presentation by multiple Web sites.

FIGS. 8A-8C are diagrams illustrating examples of customizable, tag-based data structures, such as extensible mark-up language (XML) data structures formed according to one exemplary embodiment of the present invention.

FIG. 9 is a pictorial diagram illustrating an exemplary Web page produced by a computer system formed according to one exemplary embodiment of the invention for processing messages containing stabile content.

FIGS. 10A-10E are pictorial diagrams illustrating exemplary Web pages produced by a computer system formed according to one exemplary embodiment of the invention for processing messages containing live content.

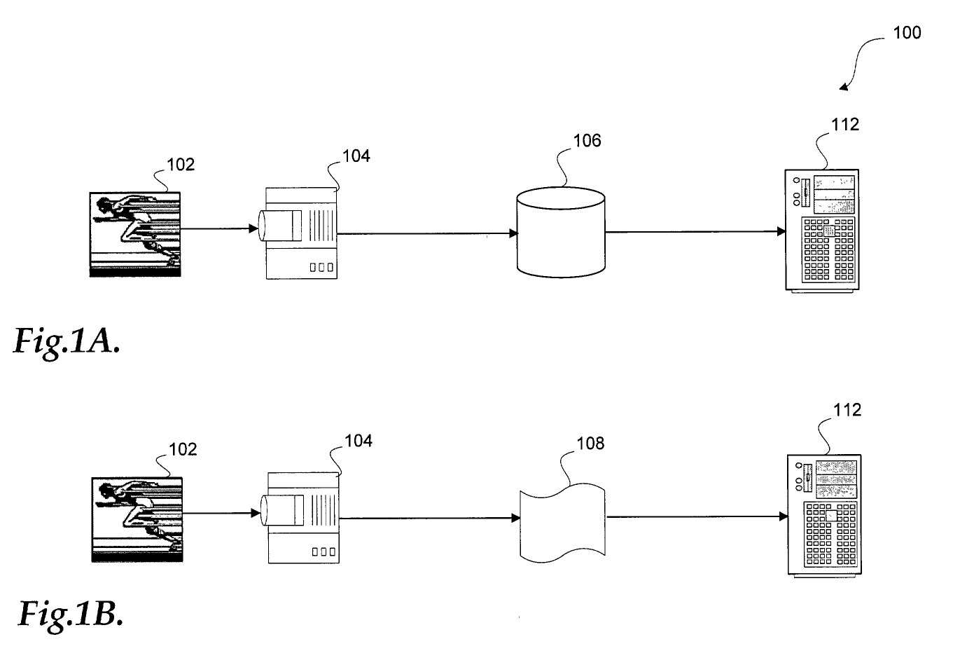

### DETAILED DESCRIPTION OF THE PREFERRED EMBODIMENT

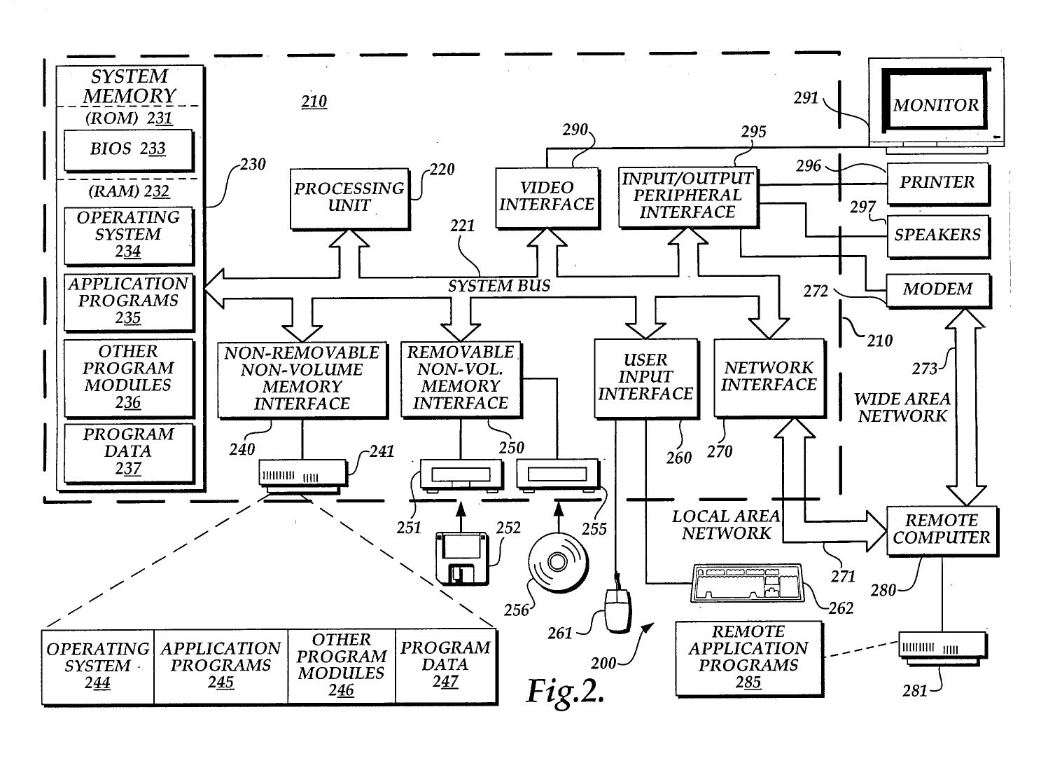

FIG. 2 illustrates an example of a suitable computing system environment 200 for practicing certain aspects of the invention. The computing system environment 200 is only one example of a suitable computing environment and is not intended to suggest any limitation as to the scope of use or functionality of the invention. Neither should the computing environment 200 be interpreted as having any dependency or requirement relating to any one or combination of the illustrated and described components.

The invention is operational with numerous other general purpose or special purpose computing system environments or configurations. Examples of well-known computing systems, environments and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention is described in the general context of computer-executable instructions, such as program modules being executed by a computer. Generally, program modules include routines, programs, objects, components, data structures, etc., that perform particular tasks or implement particular abstract data types.

The invention may also be practiced in distributed computing environments where tasks are performed by remote processing devices that are linked through a communications network. In a distributed computing environment, program modules may be located in both local and remote computer storage media, including memory storage devices.

The computing system environment illustrated in FIG. 2 includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures, including a memory bus or memory controller, a peripheral bus, and a local bus using any of a variety of bus architectures. By way of example, and not limitation, such bus architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

Computer 210 typically includes a variety of computer-readable media. Computer-readable media can be any available media that can be accessed by computer 210 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tapes, magnetic disk storage or other magnetic storage devices, or any other computer storage media. Communication media typically embodies computer-readable instructions, data structures, program modules or other data in a modulated data signal, such as a carrier wave or other transport mechanism that includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF infrared, and other wireless media. A combination of any of the above should also be included within the scope of computer-readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during startup, is typically stored in ROM 231. RAM 232 typically contains data and/or program modules that are immediately accessible and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates the hard disk drive 241 that reads from or writes to non-removable, nonvolatile magnetic media, the magnetic disk drive 251 that reads from or writes to a removable, nonvolatile magnetic disk 252, and an optical disk drive 255 that reads from or writes to a removable, nonvolatile optical disk 256, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital videotapes, solid state RAM, solid state ROM, and the like. The hard disk drive 241 is typically connected to the system bus 221 through a non-removable memory interface, such as interface 240, and the magnetic disk drive 251 and optical disk drive 255 are typically connected to the system bus 221 by a removable memory interface, such as interface 250.

The drives and their associated computer storage media discussed above and illustrated in FIG. 2 provide storage of computer-readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices, such as a keyboard 262 and pointing device 261, the latter of which is commonly referred to as a mouse, trackball, or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port, or universal serial bus (USB). A monitor 291 or other type of display device is also connected to the system bus 221 via an interface, such as a video interface 290. In addition to the monitor, computers may also include other peripheral output devices, such as speakers 297 and printer 296, which may be connected through an input/output peripheral interface 295.

The computer 210 may operate in a networked environment using logical connections to one or more remote computers, such as a remote computer 280. The remote computer 280 may be a personal computer, a server, a router, a network PC, a peer device, or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such network environments are commonplace in offices, enterprise-wide computer networks, intranets, and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the input/output peripheral interface 295, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are for illustrative purposes only and other means of establishing a communications link between the computers may be used.

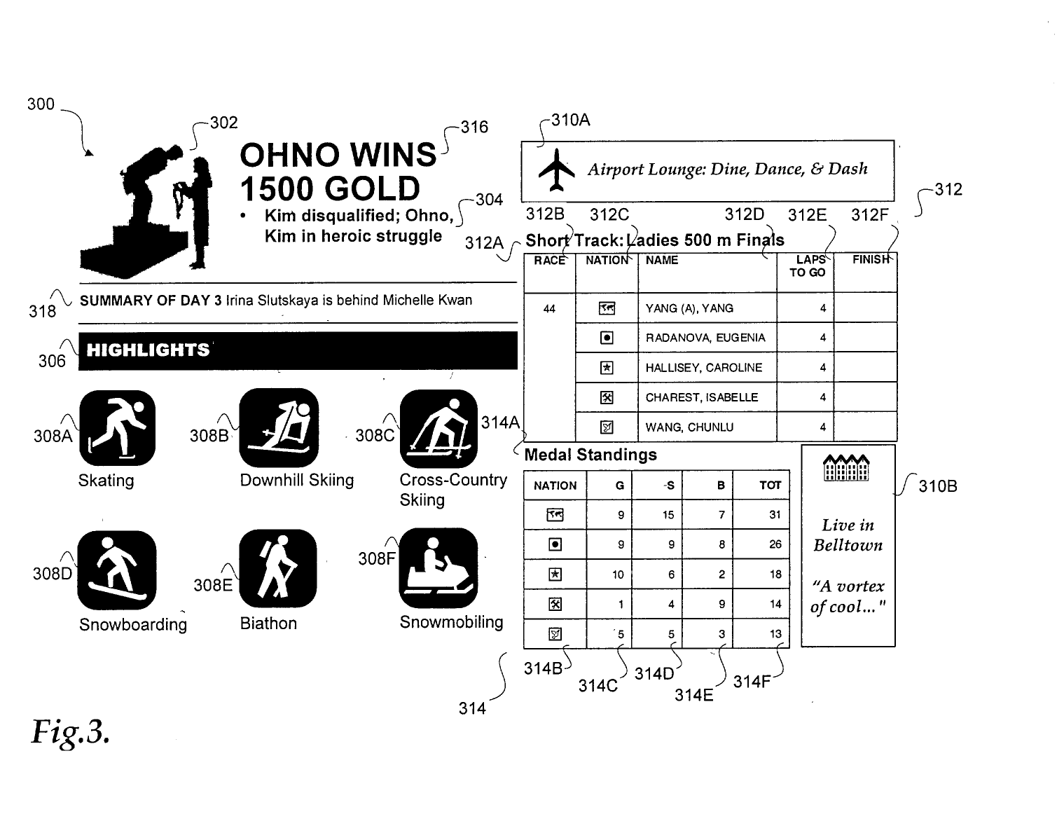

FIG. 3 illustrates an exemplary Web page 300 produced by a collection of component elements that work together to process messages containing either stabile content, live content, or both. More specifically, FIG. 3 includes a stabile content matrix 314 and a live content matrix 312. The stabile content matrix 314 results from processing stabile content and the live content matrix 312 results from processing live content. The Web page is published for the viewing of users within a short duration of time so as to enhance users' viewing experience of live content. While the Web page 300 contains primarily information pertaining to sports events, the invention is not so limited. The present invention can be used to process for online presentation any news feeds, any live Internet broadcast, any pieces of knowledge, intelligence, facts, or data, having stabile content, live content, or both.

In addition to the stabile content matrix 314 and the live content matrix 312, the Web page 300 includes an image 302 that photojournalistically presents a major news story to users. Located within the immediate proximity of the image 302 is a primary headline 316 appearing in large type and giving the gist of the news story or article that is more fully presented when a user clicks upon links formed by the headline 316 or the image 302. Just below the primary headline 316 is a secondary headline 304 showing the main points of other news stories and articles. A tertiary headline 318 that summarizes other news stories and articles is also provided. All of the headlines form links that when activated cause related articles to be displayed for viewing by a user. A section header 306 generally shown in strong graphic presentation separates elements below it from other parts of the Web page 300. A number of icons, images, or symbols 308A-308F present detailed information about a particular event, such as a sports event, when the user clicks upon one of the icons 308A-308F. Advertisements 310A, 310B, which can be static or animated, are positioned so as to attract a user's attention and enhance a user's desire to patronize the products or services related to the advertisements. Like other elements on the Web page 300, the advertisements 310A, 310B contain links to other Web pages that are accessible by clicking on the advertisements.

The stabile control matrix 314 includes published stabile content that may have just arrived from a news source, or arrived leisurely from a database or from other sources. A title 314A contains a brief, descriptive name for the matrix 314. A number of columns 314B-314F include multiple cells that contain detailed description of published stabile content. For example, column 314B describes nations that have, to date, earned medals at sports events, such as the Olympic games. The first cell of column 314B identifies the purpose of the column, i.e., that the column identifies nations. Subsequent cells of column 314B contains a flag or some other indicia identifying a particular nation. Column 314C describes gold medal counts for each corresponding nation in column 314B. Column 314D describes silver medal counts and column 314E describes bronze medal counts for each corresponding nation in column 314B. Column 314F describes total medal counts for corresponding nations.

The matrix 312 includes multiple columns 312B-312F that contain published live content. A title 312A provides a description of the content of the matrix 312. Column 312B shows the race number of a particular heat. Column 312C contains identifying indicia of the various nations participating in the race identified by column 312B. Column 312D contains the names of participating athletes. Column 312E shows the number of laps to be completed by corresponding athletes (four since none have been completed because the race has not commenced). Because no athlete has crossed the finish line, column 312F does not yet contain the finish times of the participating athletes.

Web page 300 is only one example of the many types of pages that can be used to show stabile content, live content, or both. In the case of Olympic sports events, Web pages can show medal count by country; medal count by sport; medal winners by sport; medal winners by date; medal winners by country; athlete lists by sport; athlete lists by country; athlete bios; country profiles; judges' lists; and start lists. While sport Web pages examples, in particular Olympic sport Web pages, are not shown in the drawings, it should be understood that the invention can be used to process stabile content, live content, or both to create data suitable for online presentation for many types of events, not just sports events.

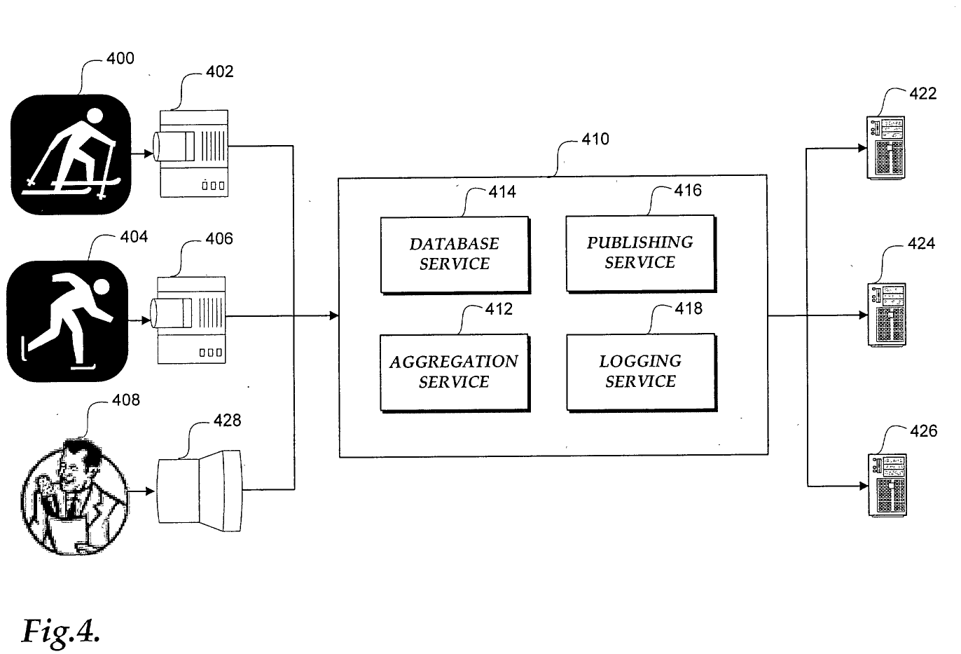

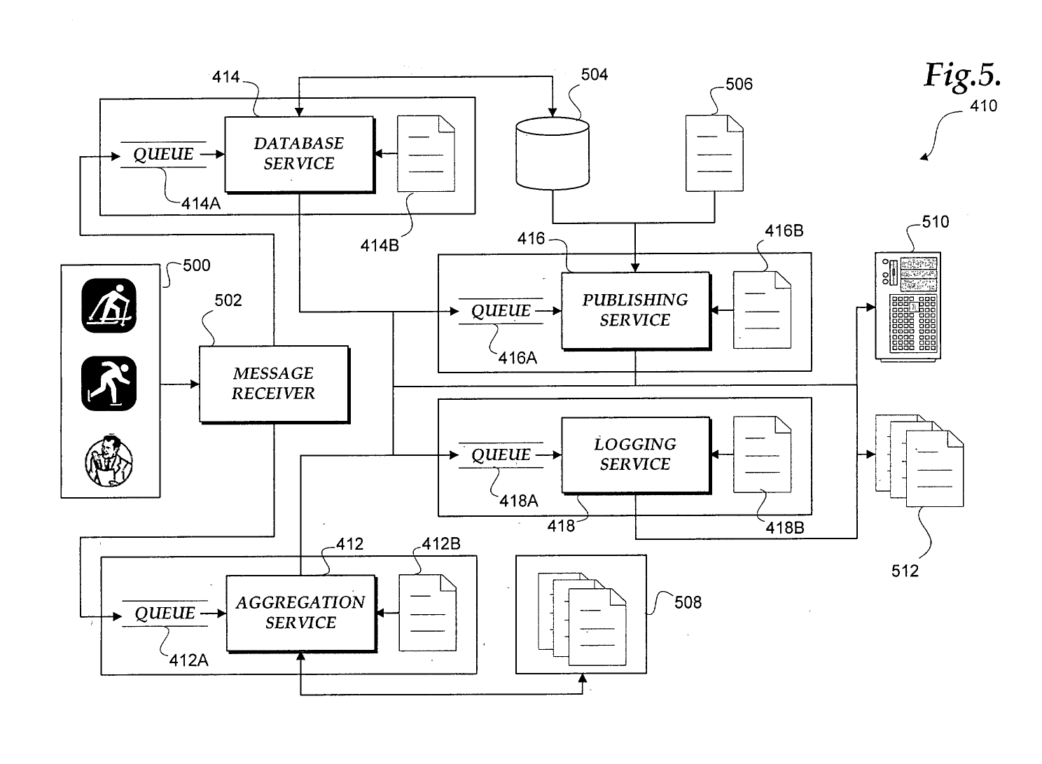

FIG. 4 illustrates an exemplary computer system 410 formed in accordance with this invention for processing stabile content, live content, or both for online presentation, such as Web pages available from multiple Web sites 422-426. More specifically, FIG. 4 illustrates live content of various events, such as skiing and skating sports events 400, 404 being captured by devices such as video cameras 402, 406. As for video cameras capturing the sporting events, the video cameras 402, 406 forward live content as messages to the computer system 410 for processing. Live content is defined to include real-time, in-progress competition results as well as other instantaneous information considered to be fresh when viewed by users within a short period of time after the events associated with the information occur. Stabile content may also be forwarded for processing by the computer system 410. Stabile content can come from a source 428 that gathers and stores information, such as judges' lists, athletes start lists, schedules, Olympics results, athlete bios, and country profiles as well as any information related to schedules, athletes, officials, weather, results, and medals standings depicted specifically by an announcer 408. Stabile content can also come from a database.

The computer system 410 includes a set of services or a collection of component elements that work together to process messages containing stabile content, live content, or both for forwarding to Web sites, such as Web sites 422-426 for online presentation. The services include a database service 414, an aggregation service 412, a publishing service 416 and a logging service 418. Although four services/component elements, 412-418, are shown separately, the present invention contemplates other embodiments with more or less than the four services/component elements by combining some of them together or breaking some of them out separately. The database service 414 produces customizable, tag-based output files for stabile content. The files are in publishable form suitable for online presentation. The aggregation service 412 produces cumulative files. The cumulative files are formed using a customizable, tag-based language. The files contain snapshots of live content in a form suitable for online presentation. The publishing service 416 is responsible for binding tag-DOC-based content files produced by the aggregation and database services to style files suitable for online presentation. The style files are formed from a customizable, tag-based language, and determine how the contents of the tag-based content files will be displayed online by controlling what will be displayed, in what format, and in what type, size, and style. Control may be associated with specific Web sites. The logging service 418 contains a history of the processing transactions performed by the other services 412-416.

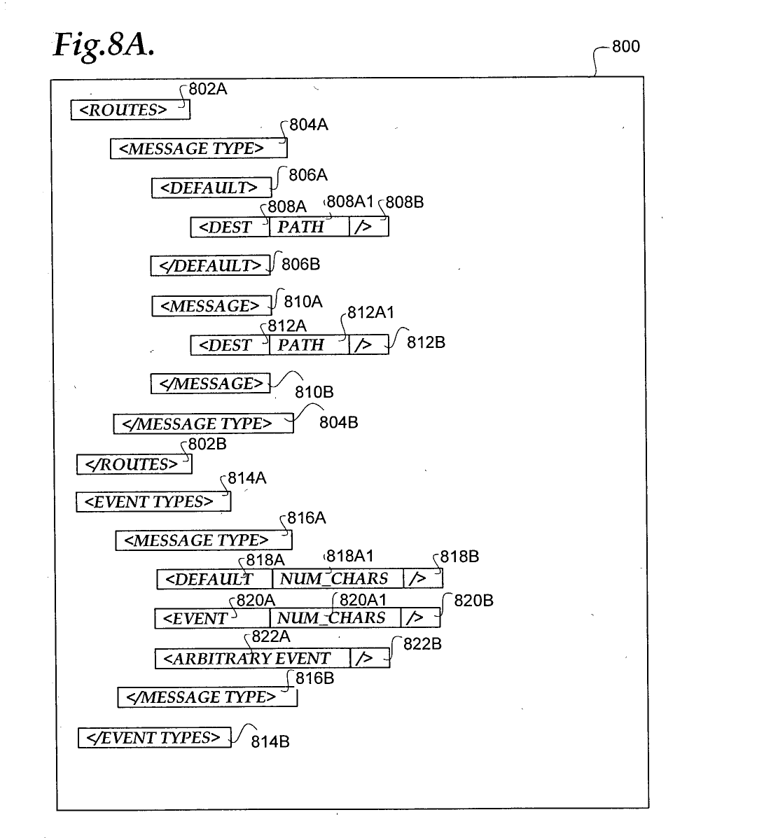

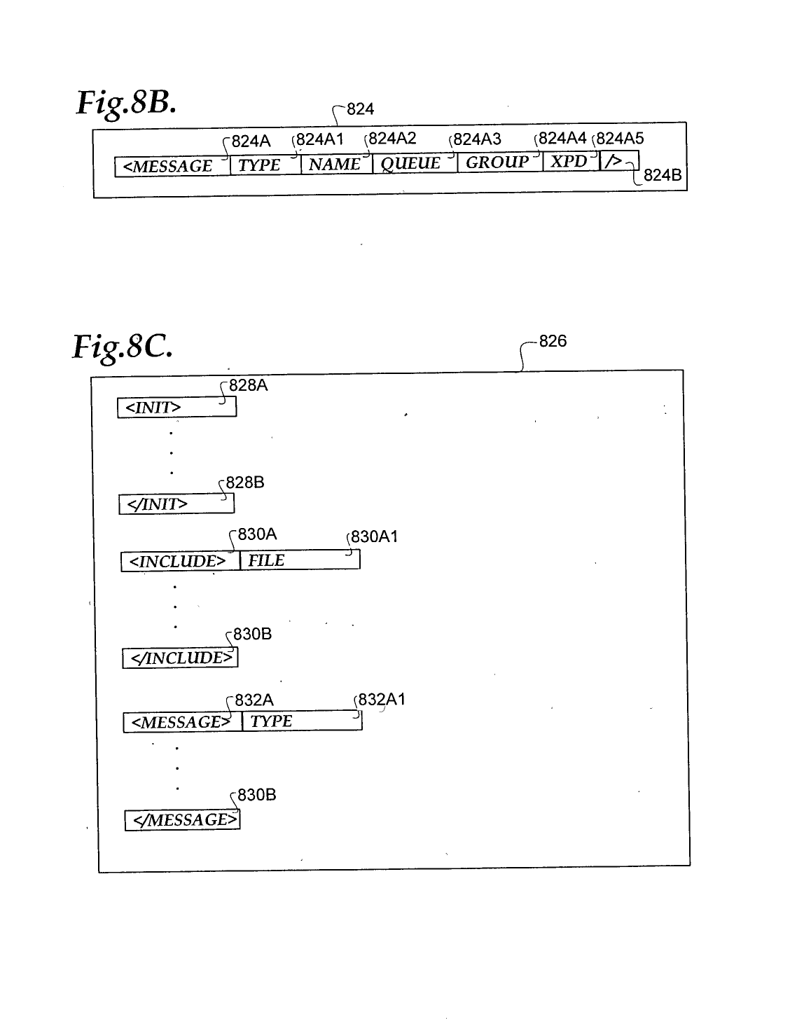

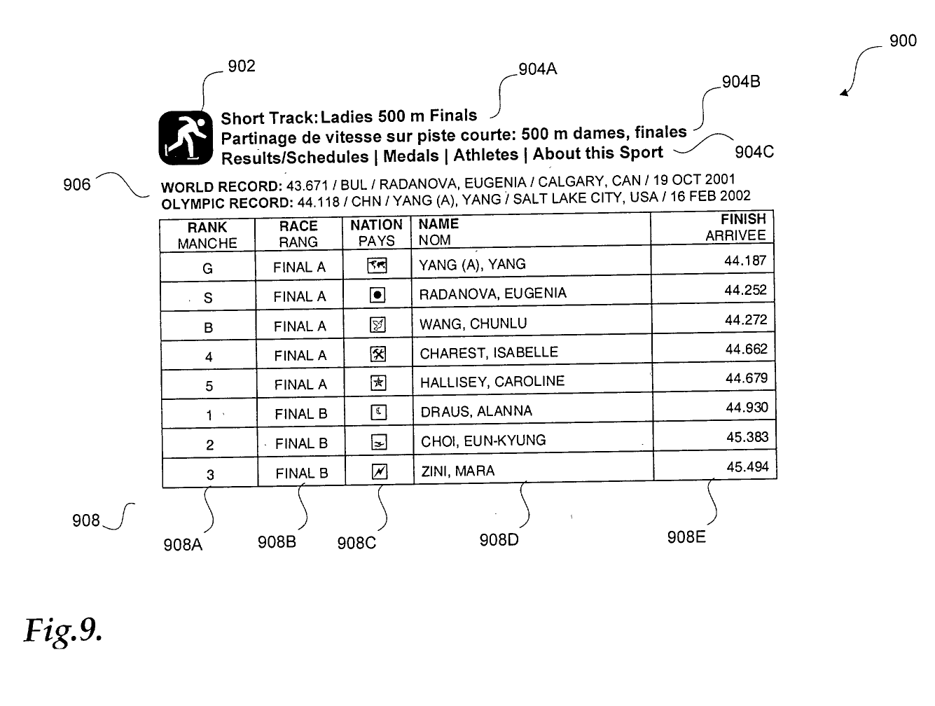

The services shown in FIG. 4 are illustrated in greater detail in FIG. 5. More specifically, FIG. 5 illustrates a source 500 that provides both stabile content and live content as messages to a message receiver 502. The messages can be in any suitable format. One suitable format includes UTF-8 encoded data written in a customizable, tag-based language, such as extensible markup language (XML). In complex athletic contests, such as the Olympic games, multiple sports, multiple medal events, and multiple sub-events may be held contemporaneously rather than sequentially. In such instances, the source 500 may send intermixed messages for different events that contain both stabile content and live content. The messages may contain information related to schedules, athletes, officials, weather, results, and medal standings. The message receiver 502, which forms part of the computer system 410, is capable of preprocessing intermixed messages and routing them to either a database service queue 414A or an aggregation service queue 412 for further processing. More specifically, routing data structure (whose schema 800 is shown in FIG. 8A and described below) is formed in a way that allows the message receiver to differentiate between many different types of messages and route them to the queue 414A-412A.

FIG. 8A is an exemplary illustration of an organizational scheme (schema) 800 of a routing data structure formed in accordance with the invention. The schema 800 is a structured framework formed from a customizable, tag-based language, such as the Extensible Markup Language (XML). As will be appreciated by those skilled in the art, any suitable tag-based language can be used as long as the chosen language provides for customizable tags that can be used to both describe data and contain data.

The schema 800 includes a beginning route tag 802A and a corresponding ending route tag 802B. The content between the beginning route tag 802A and the ending route tag 802B includes one or more beginning message type tags 804A and corresponded ending message type tags 804B, which are indicative of a message type potentially received by the message receiver 502. Nesting between each beginning message type tag 804A and ending message type tag 804B is a beginning default tag 806A and a corresponding ending default tag 806B; and a beginning message tag 810A and a corresponding ending message tag 810B. More than one set of beginning message tags 810A and ending message tags 810B may be present indicating plural messages processible by the computer system 410. Nesting inside both the beginning and ending default tags 806A and 806B and the beginning and ending message tags 810A and 810B are beginning destination tags 808A, 812A, and corresponding ending destination ending tags 808B and 812B. Between the beginning and ending destination tags are path attributes 808A1, 812A1. Each path attribute 808A1, 812A1 includes a unique address, such as a directory path or a folder path in a file system, that identifies the appropriate queue for handling the message received by the message receiver 502. If no beginning and ending message tags 810A and 810B are included, which specify the destination of the queue appropriate to handle a received message, the beginning and ending default tags 806A and 806B define a default queue for handling the message. As noted above, tag 802B is an ending route tag that corresponds to beginning route tag 802A.

The schema 800 also includes a beginning event types tag 814A and a corresponding ending event types tag 814B. the beginning event types tag 814A describes how to extract an event type from a message. Whereas the message type tag 804A between the beginning and ending route tags 802A and 802B differentiates messages based on the type of message, such as a message containing live content, the event type tag 814A differentiates the messages further, namely by events, such as a sports event. For example, there are many different sports in the winter Olympic games, such as alpine skiing, curling, and figure skating. Within the sport of figure skating, there are multiple events, such as men's singles, women's singles, mixed pairs, and mixed ice dance.

Nesting between the beginning event types tag 814A and the ending events type tag 814B, is one or more beginning message type tags 816A and corresponding ending message type tags 816B. Each message type tag 816A indicates the type of messages associated with the related type event. One message type is stabile content and another message type is live content. While other message types are possible for ease of description they are not described here. Nesting between the beginning message type tag 816A and the corresponding ending message type tag 816B is a beginning default tag 818A and a corresponding ending default tag 818B. An attribute (described below) between the beginning default tag 818A and the ending default tag 818B is used to extract an event from a message in the absence of other extraction choices. Also nesting between the beginning message type tag 816A and ending message type tag 816B is a beginning event tag 820A and a corresponding ending event tag 820B. An attribute (described below) between the beginning event tag 820A and the ending event tag 820B indicates how a particular event is to be extracted from a message. For example, a message may include an event encoded at a particular position or positions in an alphanumeric string.

As noted above, both the default tag and the event tag corresponding attributes num_chars 818A1, 820A1 that indicate the position or positions in an alphanumeric string where an event code is located.

Also nesting between the beginning message type tag 816A and corresponding ending message type tag 816B is a beginning arbitrary event tag 822A and a corresponding ending arbitrary event tag 822B. One or more attributes included in the arbitrary event tag are used to extract events that do not fall into event categories identified by the one or more event type tags.

The schema 800 is the organizational scheme from which the routing data structure used by the message receiver 502 (FIG. 5) is instantiated. In essence, the schema 800 allows the message receiver 502 to separate messages by types as well as by events. As explained hereinbefore, messages can be classified into at least two types: those that contain live content and those that contain stabile content. Messages that contain live content are separately processed because of the urgent nature of the information contained in such messages. Moreover, the ability to differentiate between live content and stabile content enhances the ability to process for online presentation. More specifically, such differentiation allows content to be processed with little delay thereby retaining the freshness of live content information and enlivening the user's viewing experience. In contrast stabile content can tolerate more processing time. The separation of messages by events allows messages to be contemporaneously processed using multi-tasking or multi-processing computer system modes of operations.

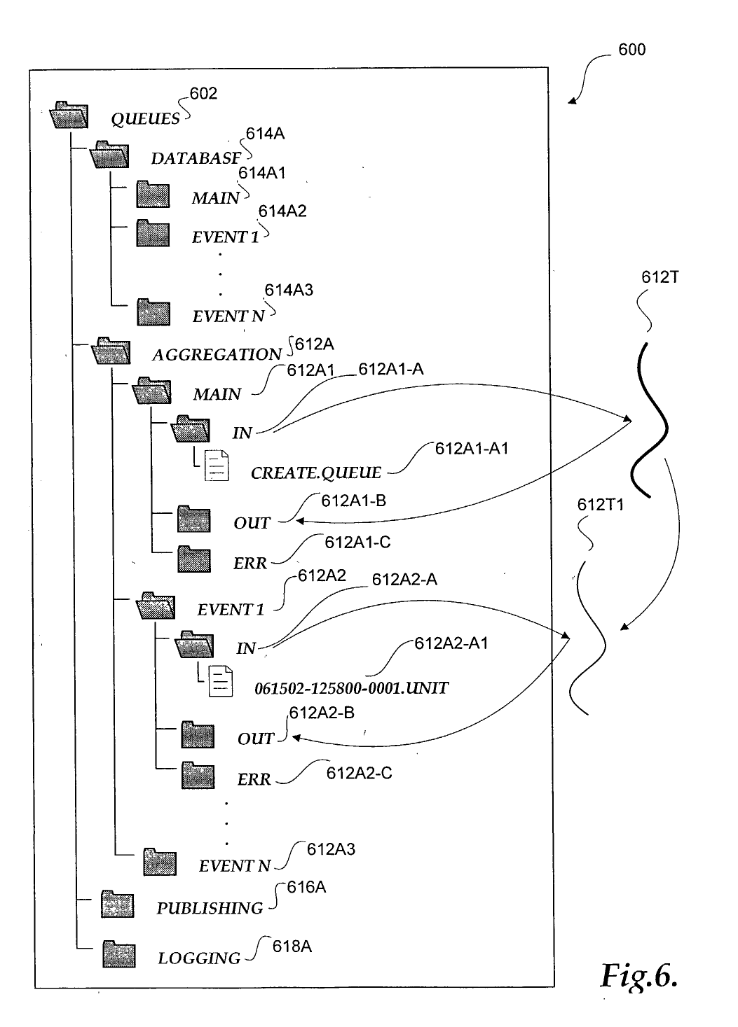

Returning to FIG. 5, the message receiver 502 routes messages containing stabile content to the database service queue 414A and messages containing live content to the aggregation service queue 412A. The aggregation service and database service queues 412A, 414A and hereinafter described publishing service and logging service queues 416A, 418A are basically multi-element data structures from which messages (elements) can be removed in the same order in which they were inserted; that is, the queues follow a first in, first out (FIFO) order. Preferably, the queues 412A-418A are implemented as directories or folders in a file system 600, such as the file system shown in FIG. 6 and described below. Such a file system can be implemented on one or more hard disks (not shown) of the computer system 410.

While the various service queues 412A-418A can be formed as directories or folders in a file system, other techniques can be used. All that is required is that the chosen technique allows for the storage of multiple messages that can be removed in the same order in which the messages were inserted into a queue. A file system has the advantage of providing an overall structure in which files are named, stored, and organized into directories containing the information needed to locate folders associated with the files.

The file system 600 shown in FIG. 6, which can occupy portions of one or more hard disks (not shown) of the computer system 410, includes a directory or folder 602 named “queues.” The queues folder 602 is a catalog for files and other directories or folders representing the aggregation service, database service, publishing service, and logging service queues 412A-418A. The queues folder 602 contains a directory or folder 614A named “database” representing the database service queue 414A; a directory or folder 612A named “aggregation” representing the aggregation service queue 412A; a directory or folder 616A named “publishing” representing the publishing service queue 416A; and a directory or folder 618A named “logging” representing the logging service queue 418A.

Contained within each of the database folder 614A, the aggregation folder 612A, the publishing folder 616A, and the logging folder 618A, is a directory or folder named “main.” For brevity of illustration and description purposes, only the database and aggregation main folders 614A and 612A are shown in FIG. 6, the publishing and logging main folders are not shown.

Each of the database, aggregation, publishing and logging folders 612A-618A also contain one or more directories or folders named “event.” Again, for brevity of illustration and description purposes only, database and aggregation event folders 612A2, 612A3, 614A2, and 614A3 are shown in FIG. 6. In the case of a sporting event version of this invention, each event folder represents a particular type of contest in a program of sports. More specifically, each event folder represents a classification used to differentiate one message from another message. For example, there are many different sports in the Olympic Games. Within each sport there can be many different events. The sport of alpine skiing includes a men's downhill event and a women's downhill event, for example. Classifying messages into one or more event folders allows a message in one event folder to be contemporaneously processed with another message in another event folder by a computer system using multi-tasking or multi-processing modes of operation. More specifically, a thread can be spawned for each event folder, allowing messages in event folders to be seemingly or actually processed at the same time. This allows live content in messages to be more quickly processed for online presentation to users for viewing.

Each of main folders and event folders contains three sub-directories or sub-folders named “in,” “out,” and “err.” For brevity of illustration and description purposes only, in, out and err subdirectories or sub-folders of the main and event folders 612A1 and 612A2 associated with the aggregation directory or folder 612A are described herein. More specifically, FIG. 6 illustrates the main folder or directory 612A1 of the aggregation folder or directory 612A having an in sub-folder 612A1-A, an out sub-folder 612A1-B, and an err sub-folder 612A1-C. FIG. 6 also illustrates that the event folder or directory 612A2 of the aggregation folder or directory 612A has an in sub-folder 612A2-A, an out sub-folder 612A2-B, and an err sub-folder 612A2-C. Each in sub-folder represents a destination where messages will be deposited for processing. Each out sub-folder contains received messages that have been successfully processed. The out sub-folders provide a way to re-execute successfully processed messages, if necessary. Each err sub-folder contains unsuccessfully processed messages.

The in sub-folder under a main folder contains messages relating to creating a queue, deleting a queue, or other queue operations whereas the in folder under an event folder contains messages regarding stabile content, live content, or both to be processed. For example, a message 612A1-A1 named “create.queue” is contained in sub-folder 612A1-A. A message 612A2-A1 named “061502-125800-0001.unit” that contains live content is contained in sub-folder 612A2-A.

After the in sub-folder of a main folder is created, the computer system 410 spawns a main thread that monitor the in folder for messages. Thus, there are four main threads, one for the in sub-folder of the main folders of each of the database folder 614A, the aggregation folder 612A, the publishing folder 616A, and the logging folder 618A. For brevity of illustration and description, only the main thread 612A1 of the aggregation folder 612A is shown in FIG. 6. In operation, the illustrated main thread 612T detects and processes create.queue message 612A1-A1. Processing of the create.queue message results in the creation of a new queue represented for example by event 1 folder 612A2, including the in sub-folder 612A2-A, the out sub-folder 612A2-B, and the err sub-folder 612A2-C contained in the event 1 folder. The main thread 612T also spawns a worker thread 612T1 for monitoring messages in the thusly created new in folder 612A2-A. After the new folder 612A2, and sub-folders 612A2-A, 612A2-B, and 612A2-C have successfully been created, the main thread 612T moves the create.queue message 612A1-A1 into the associated out folder 612A1-B. The worker thread 612T1 detects and processes messages sent to the new in sub-folder 612A2-A, such as the 061502-125800-0001.unit message 612A2-A1. If successfully processed, the worker thread 612T1 moves the processed message 612A2-A1 to the related out folder 612A2-B.

The foregoing discussion has focused on the database folder 614A and the aggregation folder 612A. However, it is to be understood that the discussion equally applies to the publishing folder 616A and the logging folder 618A. The use of directories or folders within the filing system 600 provides a way to form a path to a particular queue destination. For example, to reach the event folder 612A2, a destination path is formed by listing the directories of folders that lead from the queues folder 602 to the aggregation folder 612A, then to the event folder 612A2, and finally to the in folder 612A2-A. This destination path can be used in an instantiation of the schema 800 to route messages pertaining to a particular event of a particular type.

Returning to FIG. 5, the message receiver 502 forwards messages containing stabile content to the database service queue 414A. The database service 414 processes messages containing stabile content in accordance with instructions provided by a customizable, tag-based instruction file 414B. The instructions contained in the instruction file 414B provide directions and are interpretable by the database service 414. The database service process various types of messages and updates a database 504 that contains tables storing information relating to schedules, athletes, officials, weather, results, metal standings, and other data. Depending on the message type and the event, the instruction file 414B directs the database service 414 to produce a built list, which is a customizable, tag-based file that contains a list of Web pages (not necessarily only in hypertext mark-up language (HTML); other formats for online presentation can be included as well) to be built for presentation by Web sites 422-426. After the built list is produced, the database service 414 packages the built list as a publishing message and sends the message to the publishing service queue 416A.

The message forwarded to the queue 416A does not have to contain all of the publishable data because the publishing service 416 can directly access the database 504 to obtain additional information required to make Web pages requested by the build list. Preferably, upon initialization, the publishing service 416 is provided with a customizable, tag-based instruction file 416B. This instruction file 416B contains the instruction required by the publishing service 416 to publish various message types. For example, when a build list is received by the publishing service 416 from the database service 414, the instruction file 416B may instruct the publishing service 416 to bind information stored in the database 504 and referenced by the built list to one or more style files 506.

The style file determines how the content of the publishing message will be displayed online by a particular Web site by controlling what will be displayed, in what format, and in what type, size, and style. Each style file is a customizable, tag-based document. Each style file may be specific to a specific Web site, 422-426. Employing one or more style files 506 allows the publishing service to process portions of the data stored in the database 504 into a variety of output formats, such as extensible markup language (XML), active server pages (ASP), and hypertext mark-up language (HTML) formats, or any other output format that is customizable and tag-based. When binding is complete, the publishing service 416 produces one or more output files 512, stores the output files on the computer system 410 or places the output files 512 on a staging server 510, so that the output files 512 can be replicated to Web sites 422-426.

Messages containing live content are forward to the aggregation queue 412A. Like the database service 414 and the publishing service 416, preferably upon initialization, the aggregation service 412 is provided with an instruction file based on a customizable, tag-based language that directs the aggregation service 412 to process live content. One example of live content processing includes aggregating or cumulating results from real-time in-competition sports results.

The goal of the aggregation service 412 is to produce an instant snapshot of an event upon receiving a message containing live content related to the event. Typically, the aggregation service keeps one or more cumulative files per event. Preferably, the cumulative files are formatted in accordance with a customizable, tag-base language although other languages can be used as long as languages provide a way to produce a customizable, tag-based structure suitable for describing and containing data. In the illustrated embodiment of the invention, the aggregation service 412 stores the cumulative files in a rapid access memory 508 so as to enhance the timely performance of live content. Whenever the cumulative file for any event is updated, the aggregation service 412 finds a suitable style file and binds the style file to the cumulative file to produce updated Web pages and/or data files. After the updated Web pages and data files are formed, the aggregation service 412 forwards them as publishing messages to the publishing service queue 416A.

After the processing of messages is completed, whether successful or not, each of the aggregation, database and publishing services 412-416 sends a logging message to logging service queue 418A. The logging service 418 picks up logging messages from the logging service queue 418A and processes the messages to create reports, such as system reports, published reports, events logs, and debugging logs. Like the aggregation, database, and publishing services 412-416, the logging service 418, preferably upon initialization, is provided with an instruction file 418B. The instruction file 418B is based on a customizable, tag-based interpretable language. Any language can be used as long as the language allows the information in the instruction file 418B to be contained and described by customizable tags that can be translated and executed by an interpreter.

To recap, preferably on start-up, i.e., at initialization, each of the services 412-418 is provided with an instruction file that is based on a customizable, tag-based interpretable language. A customizable, tag-based interpretable language is a language that allows executable programs, such as the instruction files 412B-416B, to be translated into executable form and executed one statement at a time rather than being compiled before execution.

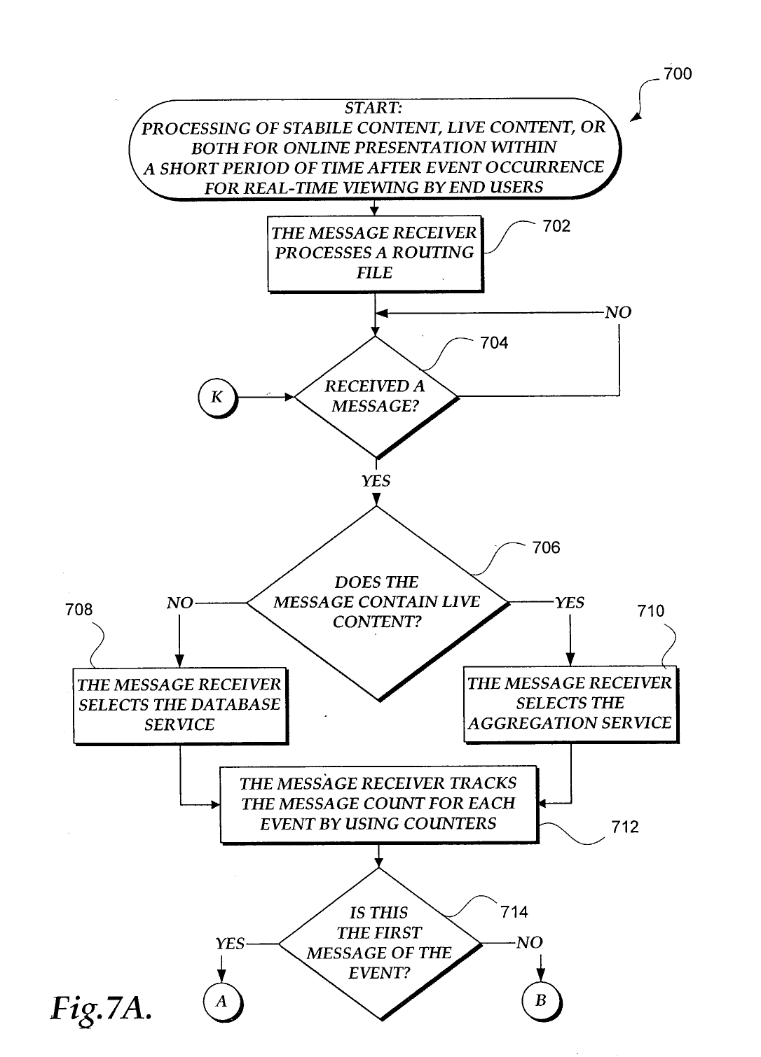

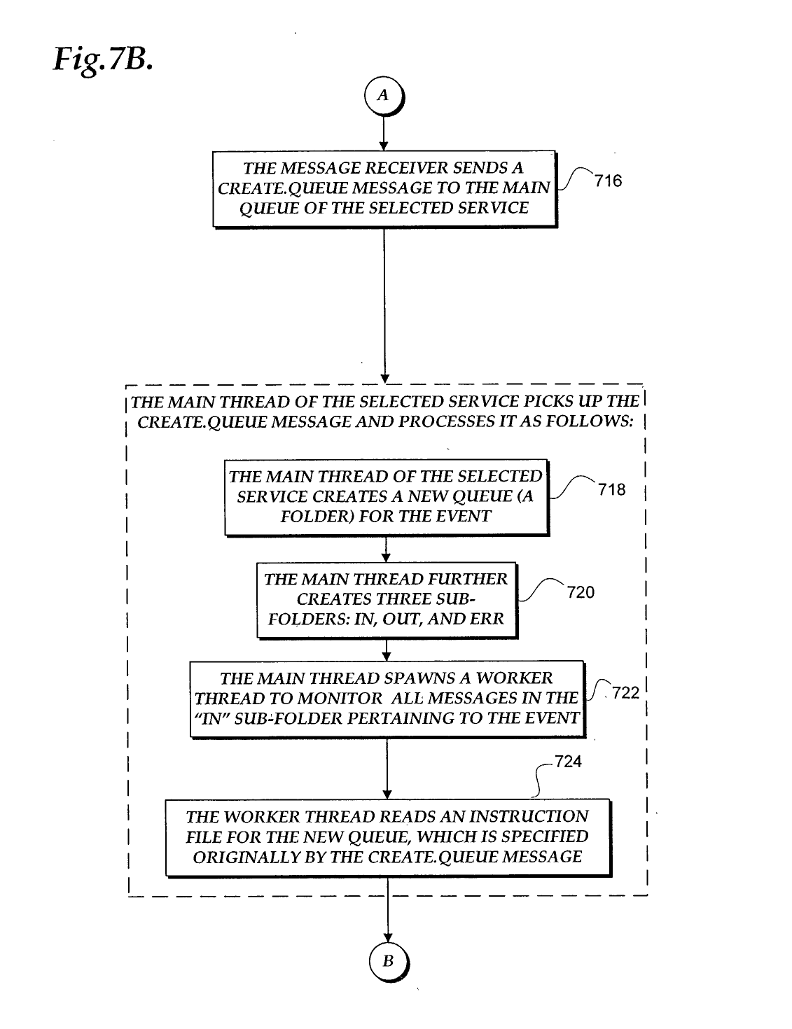

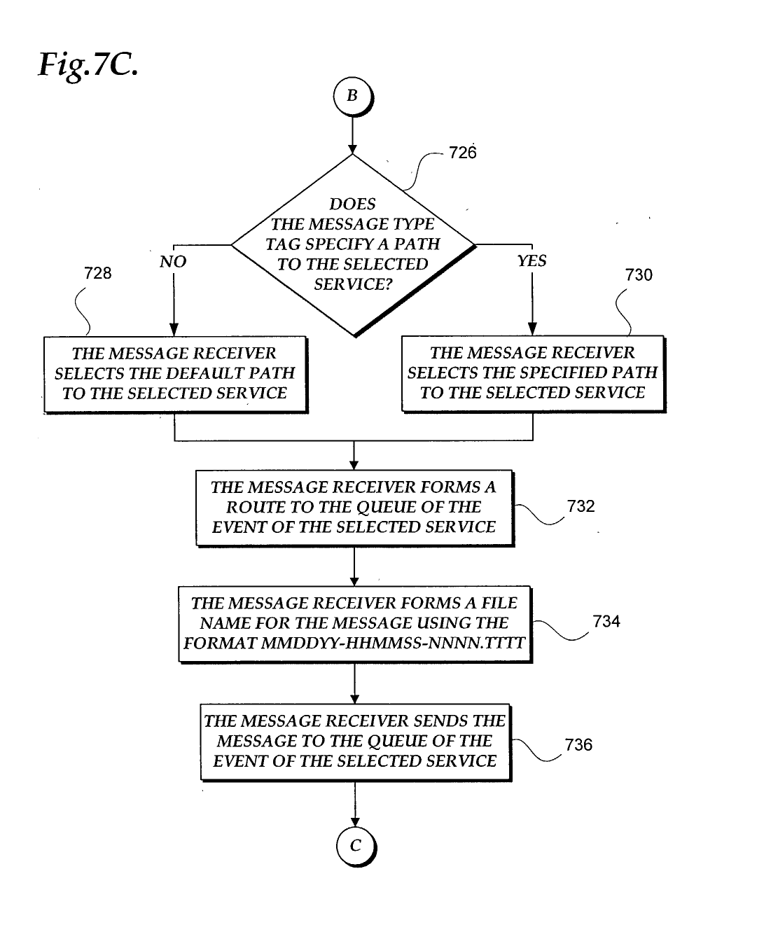

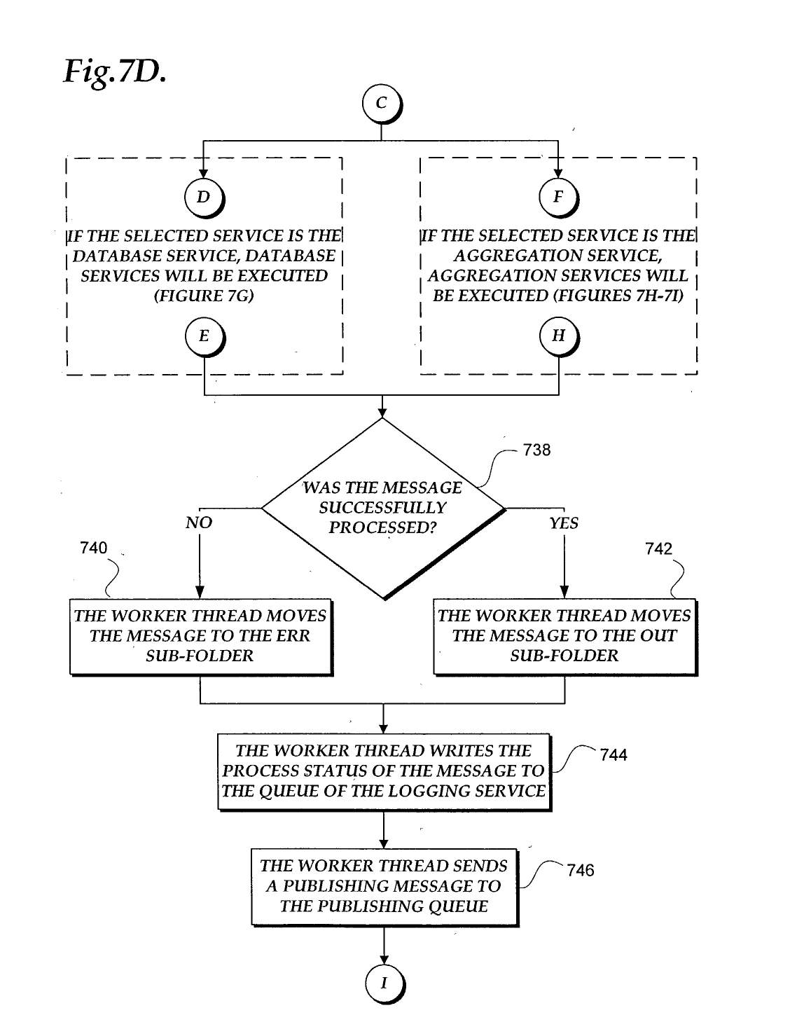

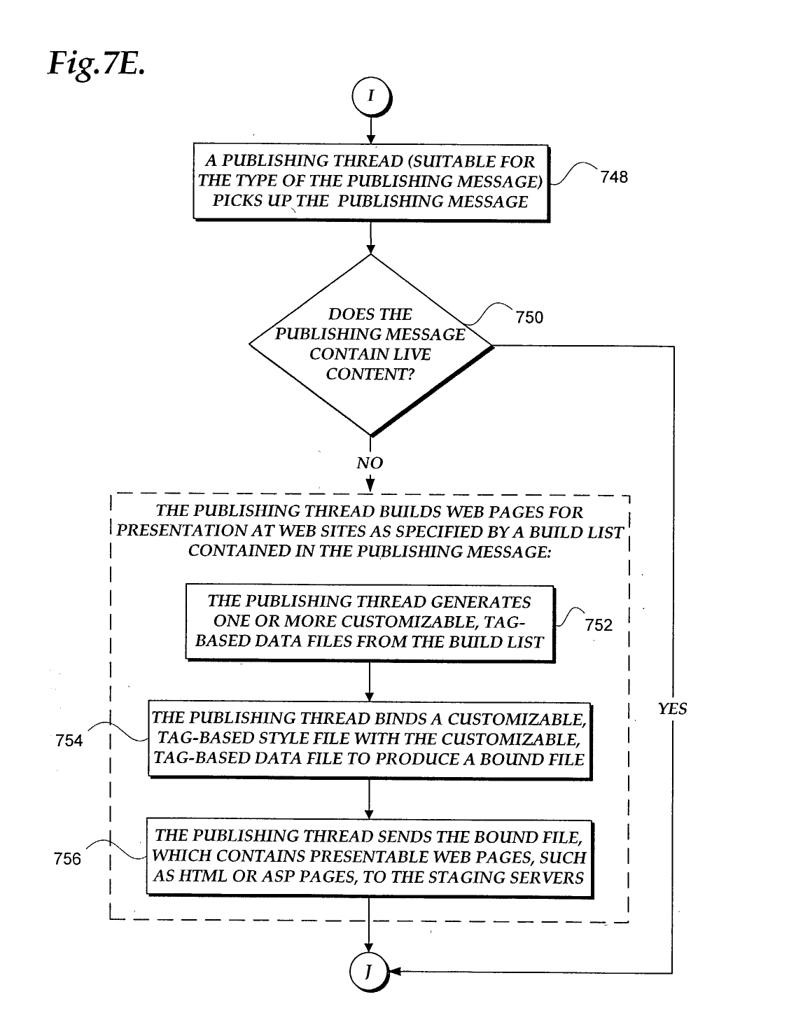

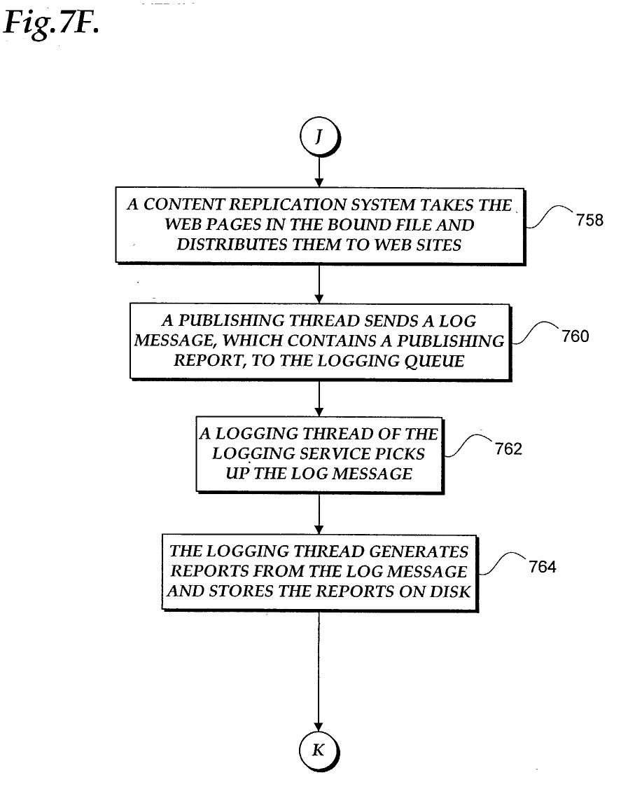

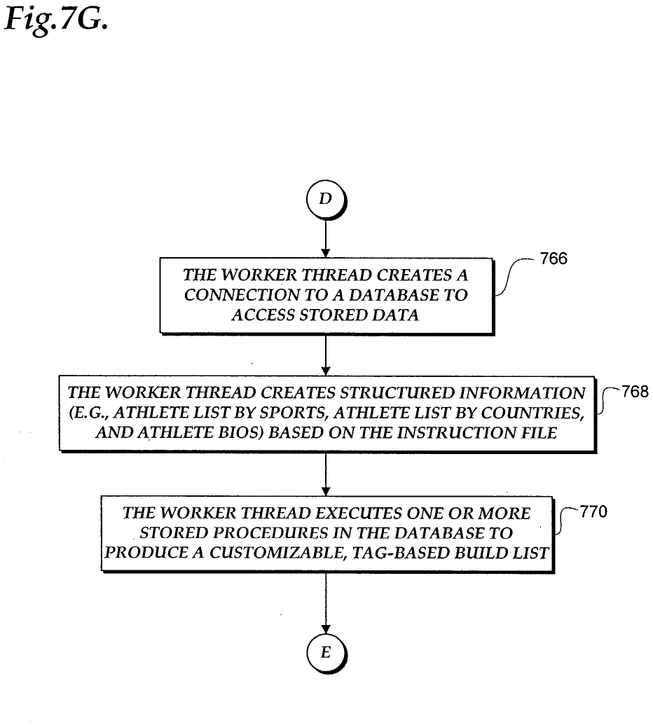

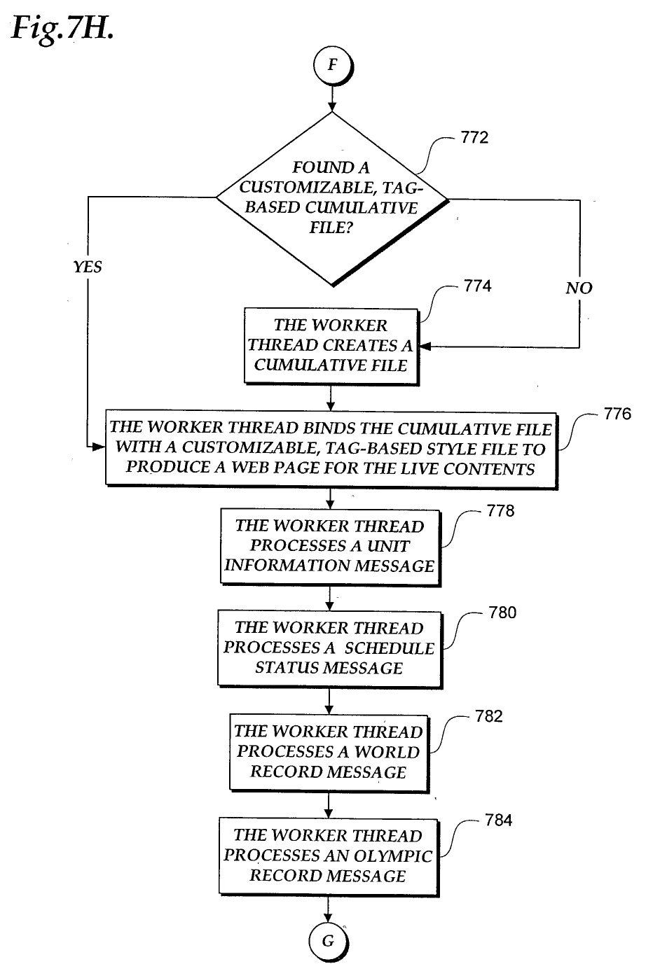

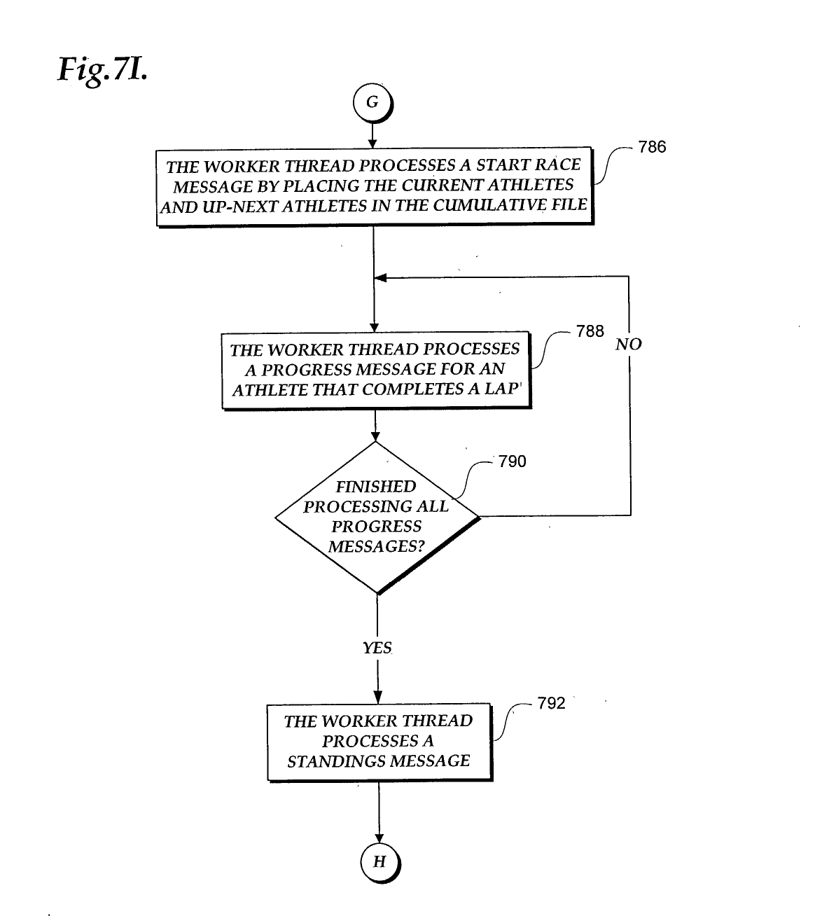

FIGS. 7A-7I illustrate a process 700 for processing stabile content, live content, or both for online forwarding to Web sites, such as at Web sites 422-424; for online presentation, within a short period of time after an event occurs; and for viewing by end users. For clarity purposes, the following description of the process 700 makes references to various elements illustrated in the computer system 410 shown in FIG. 5 and the filing system 600 shown in FIG. 6 and described above.

From a start block, the process 700 proceeds to a block 702 where the message receiver 502 processes a routing file, which is instantiated from the schema 800 illustrated in FIG. 8A. Next, at decision block 704, the message receiver 502 decides whether a message has been received from the source 500. If the answer is NO the process 700 loops back to form a waiting loop. The process 700 remains in the waiting loop until the message receiver 502 receives a message. When the answer at decision block 704 is YES, the process 700 proceeds to another decision block 706.

At decision block 706, the message receiver 502 determines whether the message contains live content related to an event. If the answer is NO, which means that the message contains stabile content, the message receiver 502 selects the database service 414, at block 708. Otherwise, if the answer at decision block 706 is YES, the message receiver 502 selects the aggregation service 412, at block 710. After the message receiver 502 has selected a service suitable for the processing of the message, the message receiver 502 forwards the message to the corresponding queue of selected service 412, 414.

For each received message, the message receiver 502 tracks the count of received messages for each event by using counters. See block 712. Using a men's singles figure skating event as an example, the message receiver 502 includes a counter that increments each time a message is received for the men's singles figure skating event. The message receiver 502 includes counters for all other events.

Next, at decision block 714, the message receiver 502 determines from the counters whether the received message is the first message received for the event. If the answer at decision block 714 is YES, the process 700 proceeds to one continuation terminal (“terminal A”). If the answer is NO, the process 700 proceeds to another continuation terminal (“terminal B”).

From terminal A (FIG. 7B) the process 700 proceeds to a block 716 where the message receiver 502 sends a create.queue message to the main queue 414A1, 412A1, of the selected service 412, 414. Preferably, the structure of the create.queue message is the form illustrated in FIG. 8B and described below.

Digressing, FIG. 8B illustrates a data structure whose schema 824 is based on a customizable, tag-based language, such as extensible mark-up language (XML). The schema 824 includes a beginning message tag 824A and corresponding ending message tag 824B. Between the beginning message tag 824A and the ending message tag 824B are a number of attributes, such as a type attribute 824A1, a name attribute 824A2, a queue attribute 824A3, a group attribute 824A4, and an XPD attribute 824A5. The type attribute 824A1 numerically identifies the type of message sent to the message receiver 502. For example, a type attribute 824A1 containing the numeric stream “001” may identify the message as a create.queue message. The name attribute 824A2 contains a letter string that indicates the name of the message. For example, the name of a create.queue message is “create.queue.” The queue attribute 824A3 contains an alphanumeric string that is to be used as the name of a folder containing messages for a particular event. For example, in FIG. 6, the name of folder 612A2 is obtained from the content of the queue attribute 824A3. The group attribute 824A4 contains a letter string identifying the event type. For example, among the many different sports in the Winter Olympic Games is alpine skiing. The chosen letter string for alpine skiing might include “AS.” The XPD attribute 824A5 contains an alphanumeric string that identifies the name of a customizable, tag-based instruction file that a worker thread can access to obtain processing information for messages located in a message queue of the type described above.

Returning to FIG. 7B, after the message receiver 502 has sent a create.queue message (from block 716), the process 700 proceeds to a collection of blocks 718, 720, 722, and 724. At block 718 the main thread, such as the main thread 612T, of the selected service picks up the create.queue message and creates a new queue (a folder) for the event, such as event folder 612A2. At block 720, the main thread further creates three sub-folders: in, out, and err (error), under the new queue created in block 718. Examples of these three sub-folders include the in sub-folder 612A2-A, the out sub-folder 612A2-B, and the err sub-folder 612A2-C. At block 722, the main thread, such as 612T, spawns a worker thread, such as 612T1, that monitors all messages in the in sub-folder (e.g., in sub-folder 612A2-A), pertaining to the event. The worker thread reads a customizable, tag-based instruction file for the newly created queue, which is specified originally by the create.queue message, specifically by the XPD attribute 824A5. The instruction file provides the worker thread with knowledge about how to handle various types of messages placed in the queue.

FIG. 8C illustrates the presently preferred organizational scheme of the new queue instruction file. More specifically, FIG. 8C illustrates a schema 826 that includes a beginning init tag 828A and corresponding ending init tag 828B. The beginning init tag 828A begins an initialization block within the schema 826 that includes processes that are executed by the worker thread upon the loading of an instantiation of the schema 826 (a customizable, tag-based instruction file).

A number of processes can be contained between the beginning init tag 828A and the ending init tag 828B. Examples of such processes are forming a connection to a database and incorporating other instruction files that are instantiations of the schema 826. Following the ending init tag 878B is a beginning include tag 830A and a corresponding ending include tag 830B. Following the beginning include tag 830A is a file attribute 830A1 that can contain an alphanumeric string for identifying the name of another instantiation of the schema 826. A beginning message tag 832A and its corresponding ending message tag 832B follow the ending include tag 830B. Located between the beginning and ending message tags 832A and 832B are messages that define the processes that will be executed to process the message identified by the beginning message tag 832A. A type attribute 832A1 included in the beginning message tag 832A contains an alphanumeric string that uniquely identifies the message type to be processed.

Returning to FIG. 7B, after the worker thread has processed the instruction file (block 724) the process 700 proceeds to terminal B. From terminal B (FIG. 7C) the process 700 proceeds to decision block 726 where the beginning message type tag 804A is checked to see if it specifies a path to the selected service. In this regard, it should be recallable that the filing system 600 organizes the services queues into a directory or folder hierarchy. Services are represented by the database folder 614A, the aggregation folder 612A, the publishing folder 616A, and the logging folder 618A. Thus, the path to the selected service means the path that lists the directories or folders that lead from the queues folder 602 to one of the services folders 614A, 612A, 616A, and 618A.

If the answer at decision block 726 is NO, the process flow proceeds to block 728 where the message receiver 502 selects the default path to the selected service. In this regard, it should be recalled that the default path is specified by the default tag 806A of the schema 800. Otherwise, the decision is YES, the message receiver 502 selects the specified path, which is described by one of the message tags 810A of the schema 800, to the selected service. Regardless of the path followed, next, at block 732, the message receiver 502 forms a route to the queue of the selected service associated with the event. An example of such a route is a route that includes the queue 602, one of the service folders 612A-618A, and an event folder related to the service folder, such as event folder 612A2. Any type of message received by the message receiver 502 that is appropriate for the new queue is sent by the message receiver 502 to the new queue using the thusly formed route.

Messages placed into the queue of a selected service are stored in a file. A variety of naming conventions can be used. In one actual embodiment of the invention, the name of the file is formed using the format MMDDYY-HHMMSS-NNNN.TTTT, where the first MM is month, DD is day, YY is year, HH is hours, the second MM is minutes, SS is seconds, NNNN is a four-digit serial number, and TTTT is the message type. In this embodiment of the invention, the four-digit serial number is the count of received messages obtained from the counters of the message receiver 502. See block 734. Next, at block 736, the message receiver 502 sends the message in the form of a file, such as file 612A2-A1, to the event queue 612A2 of the selected service. Then, the process 700 encounters another process continuation terminal (“terminal C”).

As shown in FIG. 7D, terminal C branches to two other process continuation terminals (“terminal D” or “terminal F”). Terminal C is shown as branching to both terminal D and terminal F to illustrate that the process 700 can function in a computer system 410 having multi-tasking or multi-processing modes of operation. If the selected service is the database service 414, processing steps associated with the database service 414 are executed between terminal D and an exit continuation terminal (“terminal E”). Otherwise, if the selected service is the aggregation service 412, processing steps associated with the aggregation service 412 are executed between terminal F and another exit continuation terminal (“terminal H”).

From terminal D (FIG. 7G), the process 700 enters block 766 where the worker thread creates a connection to the database 504 to access stored data. As discussed above, such data includes schedules, athletes, officials, weather, results, medal standings, as well as other stabile content. Next, the worker thread creates structured information based on the instruction file, which is an instantiation of the schema 826. The structured information obtained from the database 504 is in response to queries contained in messages received by the queue. In the case of the Olympic Game exemplary implementation of this invention, structured information includes athlete lists by sports, athlete lists by countries, athlete biographies, etc. The structured information can be based on any language as long as such language has a customizable, tag-based structure suitable for describing and containing data. Next, worker thread executes one or more stored procedures in the database 504 to produce a customizable, tag-based build list from the structured information obtained in block 768. See block 770. The build list is a list of Web pages to be built, style files to be used, and the destination of the Web pages, such as Web sites 422-426. After the build list is completed, the process proceeds to terminal E (FIG. 7D).

From terminal F (FIG. 7H), the process 700 enters decision block 772 where the worker thread checks to see if a customizable, tag-based cumulative file exists. If no such file can be found, the worker thread creates a cumulative file at block 774 and proceeds to block 776. If, on the other hand, such a file is found, the process proceeds directly to block 776. As noted above, the essence of the aggregation service 412 is to produce an instant (real time) snapshot of an event called live content. At least one cumulative file exists per event. For example, a men's 1500-meter speed skating event involves a number of athlete participants racing around a concourse over multiple laps. The cumulative file associated with such an event is designed to track the progress of each athlete participant as he completes each lap, including the times of completion. Processing of data associated with such an event must be rapidly accomplished if the live content is to be provided in real time to viewing end users. Cumulative files that reside in memory that can be quickly processed to speed execution. At block 776, the worker thread binds the cumulative file to a customizable, tag-based style file producing one or more live content Web pages. Style files capture nuances in the online presentation appropriate for each event as well as for an online site, such as a Web site.

At block 778, the worker thread processes a unit information message associated with the event whose message is being processed. Unit information message contains event related information, such as event name, discipline name, competition phase, venue, and date of event. Next, at block 780, the worker thread processes a schedule status message associated with the event. For example, if the event is about to commence, the schedule status message may contain a “coming up” indication. If, however, the competition for a particular event has started, then the schedule status message contains an “in progress” indication. Next, in this exemplary embodiment of the invention, the worker thread processes a world record message. See block 782. Then the worker thread processes an Olympic record message. See block 784. Both the world record message and the Olympic record message contain several pieces of information, such as time records, the nationality of the athlete participant, the name of the athlete participant, the place where the records were obtained, and the date that the records were obtained.

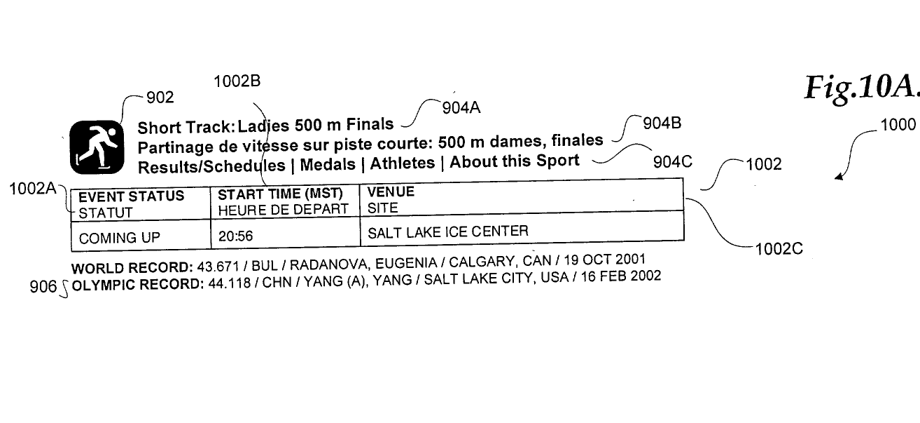

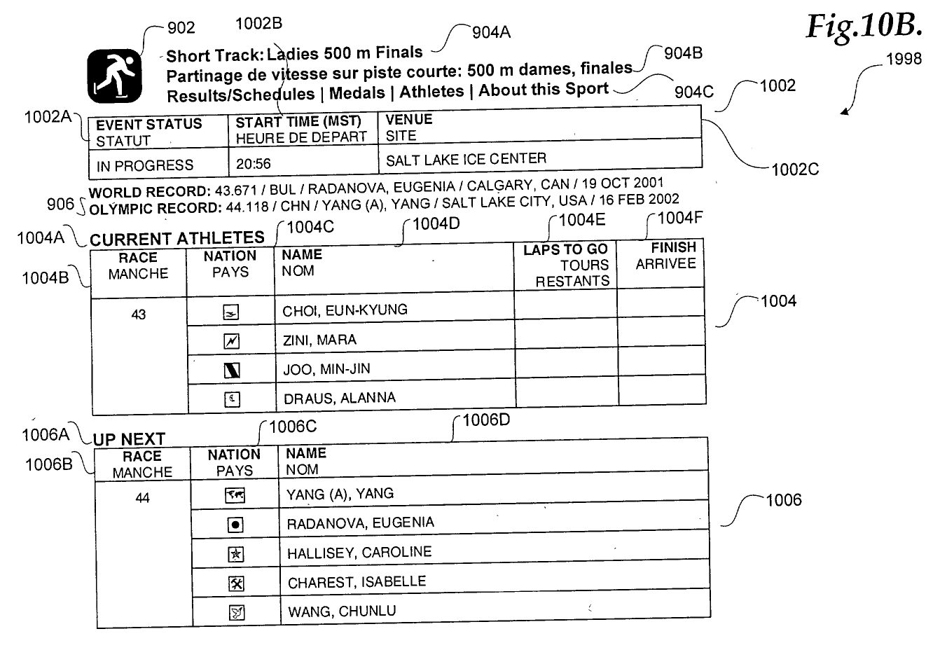

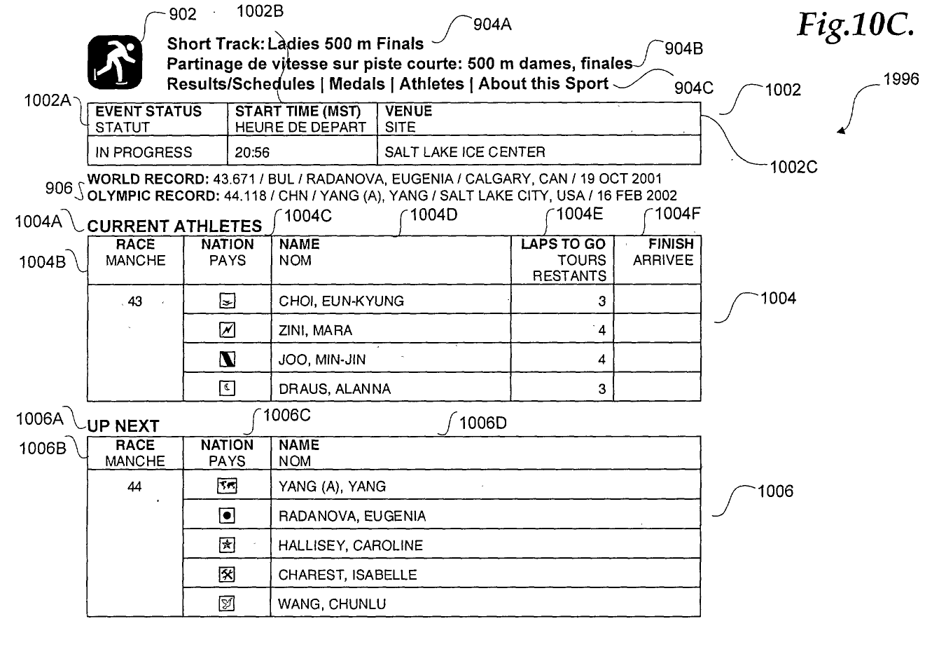

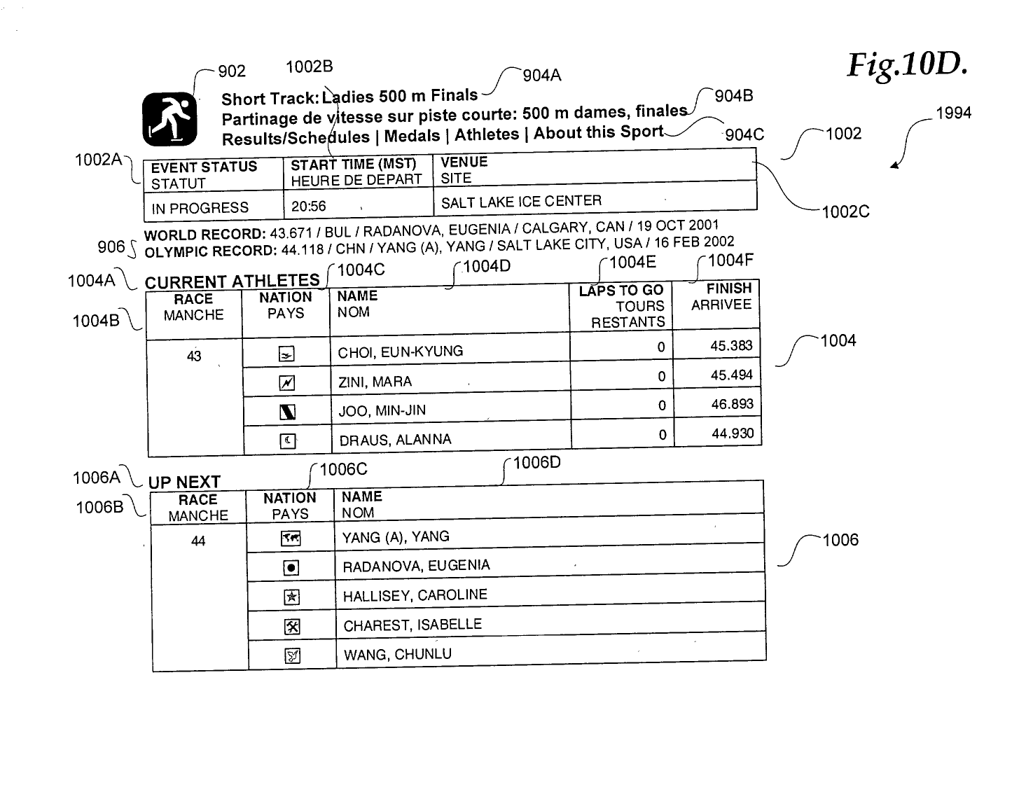

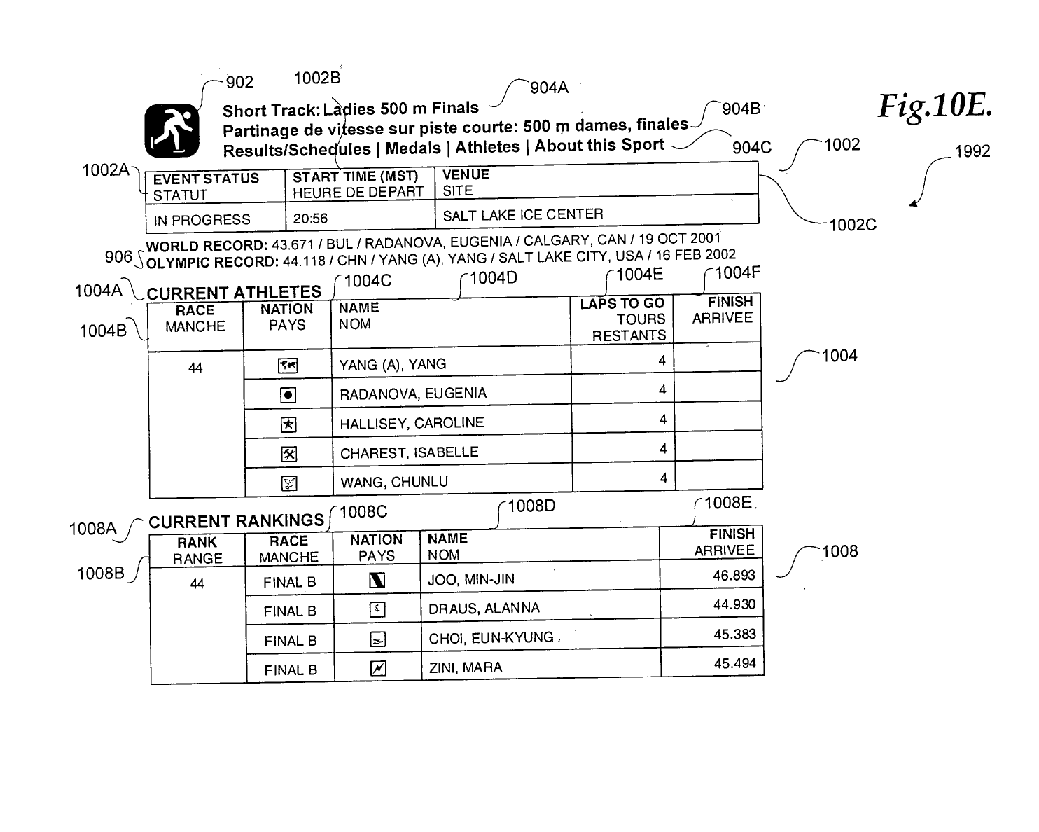

A Web page 1000 shown in FIG. 10A illustrates the information available for display at the completion of aggregation service 412 processing block 784. The Web page 1000 includes an icon, graphic, or symbol 902 identifying the relevant sports event. A heading 904A textually describes the sports event in the viewer's language-English in this example. Another heading 904B that textually describes the event in another language, such as the French language, may be included if desired. A number of hyperlinks 904C that, when activated, allow a user to receive additional information associated with the event, such as results/schedules, medals, athletes, and detailed information about this particular sport. A matrix 1002 provides the current status of the event. The matrix 1002 includes multiple columns, 1002A-1002C. Column 1002A indicates the status of the event and describes whether the event is about to commence or is in progress. Column 1002B indicates the time that the event will commence. Column 1002C indicates the venue where the event is taking place.

Returning to FIG. 7H, after aggregation service processing flow proceeds from block 784 to another continuation terminal (“terminal G”). From terminal G (FIG. 71), the process 700 proceeds to block 786 where the worker thread processes a start race message by placing current athlete participants and up-next athlete participants in the cumulative file. Current athlete participants are those who are about to commence the competition and up-next athletes are those preparing to compete once current athlete participants have completed the event.

A Web page 1998 shown in FIG. 10B illustrates the information available for display at the completion of a block 786. Web page 1998 contains elements from Web page 1000. Those elements will not be discussed further. Web page 1998 also includes a matrix 1004 that lists the current athletes about to compete in the event. A title 1004A textually describes the information contained in the matrix 1004. Column 1004B of the matrix 1004 shows the race number associated with the event. Column 1004C graphically shows the various nations competing in this event. Column 1004D textually displays the name of athlete participants. Column 1004E shows the number of laps remaining for which each athlete needs to complete. Column 1004F indicates the time record of each athlete that finished the event.

Another matrix 1006 identifies and contains data regarding athletes who are preparing to compete in the event in the next heat. The matrix 1006 includes a heading 1006A that textually describes the purpose of the matrix 1006. Column 1006B of the matrix 1006 numerically indicates the next heat of the event. Column 1006C contains graphical or iconical indicia showing nations participating in the event. Column 1006D textually describes the names of athletes participating in the next heat for this event.

Returning to FIG. 71, the process flow proceeds next to block 788 where the worker thread processes a progress message for an athlete that has completed a lap. Digressing, FIG. 10C illustrates a Web page 1996 similar to the Web page 1998, shown in FIG. 10B, updated to include additional information. More specifically, several pieces of cumulative information are now displayed in the cells of column 1004E of matrix 1004. The cell information indicates the progress of each athlete participating in the event. In this example, column 10E shows that athletes Choi and Draus each have three laps to go whereas athletes Zini and Joo each have four laps to complete.

Returning to FIG. 71, the process 700 flow proceeds to decision block 790 where a test is made to determine whether all progress messages have been processed. If the answer is NO, the process flow loops back to block 788 for further processing. Otherwise, if the answer is YES, processing proceeds to block 792. Digressing, FIG. 10D illustrates a Web page 1994 similar to the Web pages 1998 and 1996 shown in FIGS. 10B and 10C, updated to show the time records of the various athletes competing in the event. More specifically, because all athletes shown in column 1004D have completed the race, column 1004E shows that none of the athletes have additional laps to complete. Moreover, column 1004F lists the athletes' completion times.

Returning to FIG. 71, next, at block 792, the worker thread processes a standings message. Digressing again, FIG. 10E illustrates a Web page 1992 similar to the Web pages 1998, 1996, and 1994 shown in FIGS. 10B, 10C, and 10D updated to show the results of the processing performed by block 792. More specifically, column 1004B of matrix 1004 now contains the numerical designation of the heat that was previously displayed by column 1006B of matrix 1006 in FIG. 10D. Column 1004C now lists the participating nations previously in column 1006C of matrix 1006. The athletes listed in column 1004D are also different. Because FIG. 10E shows a new heat, column 1004E displays the total number of laps for which these athletes have to complete. Column 1004F contains no data because this particular heat has not commenced.

While Web page 1992 does not include matrix 1006, Web page 1992 does include another matrix 1008. Matrix 1008 includes a heading 1008A indicating that the matrix contains information pertaining to the current rankings of athletes who competed in the previous heat. These athletes are listed in column 1008B. Column 1008C displays the race number. Column 1008D identifies the various nations whose athletes participated in the previous heat. Column 1008E lists the athletes. Column 1008F displays the time records for each listed athlete. Returning to FIG. 71, from block 792 the process flow enters terminal H.

From either terminal E or terminal H (FIG. 7D), the process 700 enters decision block 738 where a test is made to determine whether the message was successfully processed. If the answer is NO, the process flow proceeds to block 740 where the worker thread moves the message to the err (error) sub-folder. If instead the answer at decision block 738 is YES, the worker thread moves the message to the out sub-folder. See block 742. Next, at block 744, the worker thread writes the process status of the message to the queue of the logging service 418. Then, the worker thread sends a publishing message, which contains either the build list from the database service 414 or generated Web pages from the aggregation service 412, to the publishing queue 418A. See block 746. Next, the process 700 enters another process continuation terminal (“terminal I”).

From terminal I (FIG. 7E) the process 800 enters block 748 where a publishing thread, which is suitable for the type of the publishing message, picks up the publishing message for processing. In this regard one or more publishing threads may have been spawned by the publishing service 416 at start-up. Each thread is responsible for certain types of published online presentations, such as Web page presentations. A test is made at decision block 750 to determine whether the publishing message contains live content. If the answer is YES, the process flow proceeds to another process continuation terminal (“terminal J”). Otherwise, if the answer is NO, processing proceeds to a collection of blocks 752-756 where the publishing thread builds Web pages for supplying to Web sites 422-426. Because the answer is NO at decision block 750, the publishing message contains publishable stabile content but not live content. At block 752 the publishing thread generates one or more customizable, tag-based data files from the build list referenced in the publishing message. Then, at block 754, the publishing thread binds a customizable, tag-based style file with a customizable, tag-based data file to produce a bound file. The bound file contains one or more presentable Web pages, such as HTML or ASP pages. The publishing thread sends the bound file to staging servers 510. See block 756. Then the process flow enters terminal J.

From terminal J (FIG. 7F), the process 700 enters block 758 where a content replication system takes the Web pages in the bound file and distributes them to the Web sites 422-426. Any content replication system can be used as long as the content replication system includes a content delivery process that caches Web pages on geographically dispersed servers to enable faster delivery of Web pages. The publishing thread then sends a log message, which contains a publishing report, to the logging queue 418A. See block 760. A logging thread of the logging service 418 picks up the log message. See block 762. Next, at block 764, the logging thread generates reports, which can be in any format, such as HTML, ASP, or XML from the log message and stores the reports on hard disks or other storage media on the computer system 410 for subsequent retrieval. Then the process 700 enters another process continuation terminal (“terminal K”), which directs the process flow back to decision block 704 (FIG. 7A) and the process cycle described above is repeated.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer system for processing multiple messages containing live content for online presentation to enhance the viewing experience of a user, the system comprising:
an aggregation service for processing messages that contain live content to produce publishing messages, the aggregation service being associated with a customizable, tag-based instruction file that is used by the aggregation service to process live content to produce the publishing messages, the customizable, tag-based instruction file allowing the aggregation service to adapt to changes in the messages that contain live content; and
a publishing service for processing the publishing messages for online presentation.

2. The system of claim 1, wherein the multiple messages also contain stabile content, the system further comprising a database service for processing messages that contain stabile content to produce publishing messages, the database service being associated with a customizable, tag-based instruction file that is used by the database service to process messages so as to produce output files being referenced or contained in publishing messages.

3. The system of claim 2, further comprising a message receiver for receiving multiple types of messages, the message receiver being associated with a customizable, tag-based instruction file that is used by the message receiver to route a message according to its type to the aggregation service, the database service, and the publishing service.

4. The system of claim 3, wherein the publishing service is associated with a customizable, tag-based instruction file that is used by the publishing service to process a publishing message based on the type of the publishing message.

5. The system of claim 4, wherein the publishing service binds the output files to customizable, tag-based style files to produce Web pages for supplying at Web sites for viewing by users.

6. The system of claim 5, further comprising a logging service for processing logging messages that are indicative of the status of the processing of messages by at least one of the aggregation service, the database service, and the publishing service, the logging service being associated with a customizable, tag-based instruction file that is used by the logging service to process logging messages.

7. The system of claim 6, wherein the aggregation service processes live content to produce cumulative files that contain a snapshot of live content, at least one cumulative file being capable of being bound to the customizable, tag-based style files.

8. For use in a computer system, a method for processing multiple messages containing live content for online presentation to enhance the viewing experience of a user, the method comprising:
processing live content of messages to produce publishing messages by a customizable, tag-based instruction file that is used to process live content, the customizable, tag-based instruction file being adaptable to changes in the messages that contain live content; and
processing publishing messages for online presentation.

9. The method of claim 8, wherein the multiple messages also contain stabile content, the method further comprising processing messages that contain stabile content to produce publishing messages by a customizable, tag-based instruction file that is used to process the messages so as to produce output files being referenced or contained in the publishing messages.

10. The method of claim 9, further comprising routing a message according to its type by a message receiver, the message receiver being associated with a customizable, tag-based instruction file that is used to route messages.

11. The method of claim 10, wherein processing publishing messages includes using a customizable, tag-based instruction file to process a publishing message based on the type of the publishing message.

12. The method of claim 11, wherein processing publishing messages includes binding the output files of the publishing messages to customizable, tag-based style files to produce Web pages for supplying at Web sites for the viewing by users.

13. The method of claim 12, further comprising logging the status of the processing of messages by using a customizable, tag-based instruction file to process logging messages.

14. The method of claim 13, wherein processing live content includes producing cumulative files that contain a snapshot of live content, at least one cumulative file being capable of being bound to the customizable, tag-based style files.

15. For use in a computer system, a computer-readable medium having computer-executable instructions for performing a method of processing multiple messages containing live content for online presentation to enhance the viewing experience of a user, the method comprising:
processing live content of messages to produce publishing messages by a customizable, tag-based instruction file that is used to process live content, the customizable, tag-based instruction file being adaptable to changes in the messages that contain live content; and
processing publishing messages for online presentation.

16. The computer readable medium of claim 15, wherein the multiple messages also contain stabile content, the method further comprising processing messages that contain stabile content to produce publishing messages by a customizable, tag-based instruction file that is used to process messages so as to produce output files being referenced or contained in the publishing messages.

17. The computer readable medium of claim 16, further comprising routing a message according to its type by a message receiver, the message receiver being associated with a customizable, tag-based instruction file that is used to route messages.

18. The computer readable medium of claim 17, wherein processing publishing messages includes using a customizable, tag-based instruction file to process a publishing message based on the type of the publishing message.

19. The computer readable medium of claim 18, wherein processing publishing messages includes binding the output files of the publishing messages to customizable, tag-based style files to produce Web pages for supplying at Web sites for the viewing by users.

20. The computer readable medium of claim 19, further comprising logging the status of the processing of messages by using a customizable, tag-based instruction file to process logging messages.

21. The computer readable medium of claim 20, wherein processing live content includes producing cumulative files that contain a snapshot of live content, at least one cumulative file being capable of being bound to the customizable, tag-based style files.

22. A computer-readable medium having a customizable, tag-based data structure stored thereon for use in routing multiple messages each containing live content for online presentation to enhance the viewing experience of a user, the data structure comprising:
a route tag for indicating multiple routes to channel messages of various types; and
an event types tag for indicating multiple events associated with the messages.

23. A computer-readable medium having a customizable, tag-based data structure stored thereon for use in defining messages to process containing live content for online presentation to enhance the viewing experience of a user, the data structure comprising:
a message tag that is indicative of a message to process containing live content, the message tag including a type attribute that numerically identifies a type of the message, a name attribute that textually describes a name of the message, a queue attribute that alphanumerically describes a queue into which the message is to be placed, a group attribute that textually describes an event type of the message, and a file attribute that alphanumerically identifies a name of a customizable, tag-based instruction file that a thread can access to obtain processing information to process the message located in the queue described by the queue attribute.

24. The computer-readable medium having a customizable, tag-based data structure stored thereon for use in defining a customizable, tag-based instruction file that a thread can access to obtain processing information to process multiple messages each containing live content for online presentation to enhance the viewing experience of a user, the data structure comprising:
an init tag for indicating processes that are to be executed by the thread upon loading of an instantiation of the data structure;
an include tag for indicating other instantiations of the data structure; and
a message tag for indicating processes that will be executed to process a message of a particular type.
